(19) United States
(12) Patent Application Publication
(10) Pub. No.: US 2025/0021817 A1
(43) Pub. Date: Jan. 16, 2025

(54) METHOD FOR CALCULATING DECISION VARIABLES

(71) Applicant: METATECH (AP) INC., New Taipei City (TW)

(72) Inventors: YING-CHEN YANG, Taipei City (TW); TZU-LUNG SUN, New Taipei City (TW); YEONG-SUNG LIN, Taipei (TW); TSUNG-CHI CHEN, New Taipei City (TW)

(21) Appl. No.: 18/765,374

(22) Filed: Jul. 8, 2024

Related U.S. Application Data
(60) Provisional application No. 63/525,786, filed on Jul. 10, 2023.

(51) Int. Cl. G06N 3/08

(52) U.S. Cl. CPC G06N 3/08

(57) ABSTRACT

A method for calculating decision variables is configured to calculate the unconfirmed decision variables. First, the method provides a trained predictive mode obtained by machine learning through a machine learning method on a dataset. Next, the method transforms the objective function of the trained predictive model from a constrained objective function to an unconstrained objective function. The method then solves the optimization problem of the unconstrained objective function, wherein the optimizer, trained with the trained predictive model, calculates gradients to facilitate the solution process. Additionally, the samples from the dataset used to train the trained predictive model can be utilized to determine the initial samples for solving the optimization problem. The method for calculating decision variables of the invention can also add a dummy layer in front of the trained predictive model. The optimizer, starting from the initial sample, calculates the arc weight values between the dummy layer and the input layer as the unconfirmed decision variables.

### BACKGROUND OF THE INVENTION

### 1. Field of the Invention

The present invention relates to a method for calculating decision variables, and more particularly, to a method for deducing decision variables in reverse by using an algorithm based on optimization techniques, an optimizer built into an artificial intelligence neural network training platform, and a trained predictive model.

### 2. Description of the Prior Art

With advancements in medical engineering technology, there has been a profound impact on the healthcare field and an increased application of regenerative medicine in clinical settings. Regenerative medicine primarily utilizes the regenerative capabilities of cells to repair damaged tissues and organs. Its applications are extensive, and by integrating tissue engineering and molecular biology techniques, it holds promise for improving and treating previously difficult-to-treat diseases such as diabetes, neurological disorders, cardiovascular diseases, and cancer. Currently, regenerative medicine mainly applies to tissue engineering and regenerative therapies, organ transplantation and regeneration, tissue regeneration and repair, cancer treatment, neural regeneration, immune cell therapy, and stem cell therapy. Among these, research and application in cell therapy within regenerative medicine are garnering increasing attention. Cell therapy is the process of culturing or processing cells from a human body in vitro and then transplanting the cells to the human body to replace or repair damaged tissue and/or cells.

Recently, many governments have gradually opened up the application of cell therapy within their countries. Consequently, more domestic and international scholars are engaging in cell therapy research, leading to significant advancements in treating various diseases. For example, autologous fibroblasts are used to treat skin defects, autologous chondrocytes are used to repair knee cartilage defects, and autologous bone marrow mesenchymal stem cells are used to treat spinal cord injuries. Additionally, the quality of cell therapy products directly affects the safety and efficacy of the treatment. Therefore, the cell culture requires strict control of cell growth conditions and real-time monitoring of culture and environmental parameters to prevent contamination or poor quality during cell cultivation. Furthermore, in the previous research, the high variability between cells from different individuals means that the optimal culture and environmental parameters for cell preparations vary for each case. Therefore, during manufacturing, each cell preparation requires adjustments to various decision variables (i.e., process parameters) to achieve the desired results. Hence, it is impossible to produce cell preparations with fixed decision variables. Moreover, due to the complexity and interrelatedness of the process, conventional techniques typically only optimize a single parameter, neglecting the comprehensive interaction effects among various parameters throughout the entire process.

Conventional techniques utilize machine learning to train on large sample datasets to obtain predictive models. The predictive models can input various process parameters and generate prediction results for cell culture. Consequently, users can simulate the effects of their designed cell culture processes in advance. However, the aforementioned predictive models trained through machine learning cannot deduce the decision variables in reverse for the cell culture process based on the user's expected results. In other words, users still need to try numerous decision variables during process design, resulting in a labor-intensive and resource-consuming design and improvement process for the culture process. In addition to cell processes, predictive models obtained through machine learning in other fields also face the inability to deduce decision variables in reverse.

Therefore, it is necessary to develop a method that can accurately deduce the decision variables in reverse to meet target results using a trained predictive model to solve the problems in the prior art.

### SUMMARY OF THE INVENTION

In view of this, one scope of the present invention is to provide a method for calculating decision variables to solve the aforementioned problems. The method for calculating decision variables comprises the following steps of: providing a trained predictive model, the trained predictive model being obtained by machine learning through a machine learning method, the trained predictive model comprising an input layer and an output layer, the dataset comprising a plurality of samples, and each of the samples comprising a plurality of sample parameters, the trained predictive model for inputting a plurality of input variables through the input layer and generating a predicted result corresponding to the input variables through the output layer; setting a target result corresponding to the predicted result of the trained predictive model; selecting at least one sample from the samples with the predictive result of the trained predictive model matching the target result as at least one anchor samples to form a multi-dimensional subspace, and determining an initial sample in the multi-dimensional subspace; obtaining a gradient by minimizing an objective function of the trained predictive model through an optimizer used to generate the trained predictive model; increasing the sample parameters of the initial sample by the step size along the opposite direction of the gradient and inputting the sample parameters after increasing the step size into the trained predictive model to confirm whether the predictive result generated by the trained predictive model matches the target result; and using the sample parameters after increasing the step size as the unconfirmed decision variables if the prediction result matches the target result.

Wherein, the method for calculating decision variables further comprises the following steps of: providing a plurality of confirmed decision variables and calculating a first vector of the confirmed decision variables; obtaining a plurality of corresponding sample parameters from the sample parameters of the samples respectively based on the confirmed decision variables, and calculating a second vector from the corresponding sample parameters; comparing the first vector with the second vector of each of the samples and comparing the prediction results generated by the trained predictive model for each of the samples with the target result to obtain a reference sample from the samples, wherein the second vector of the reference sample is close to or matches the first vector, and the prediction result of the reference sample is close to or matches the target result; and using the reference sample as the initial sample.

Another scope of the present invention is to provide a method for calculating decision variables and the method comprises the following steps of: providing a trained predictive model, the trained predictive model being obtained by machine learning through a machine learning method on a dataset comprising a plurality of samples, each of the samples comprising a plurality of sample parameters, the trained predictive model being configured to input a plurality of decision variables and produce a predictive result corresponding to the decision variables, the decision variables comprising a plurality of confirmed decision variables and a plurality of unconfirmed decision variables; setting a target result corresponding to the prediction result of the trained predictive model; comparing the confirmed decision variables with a plurality of corresponding sample parameters corresponding to the confirmed decision variables in the samples to select a candidate sample when the corresponding sample parameters are close to or match the confirmed decision variables; inputting the other sample parameters of the candidate sample, the other sample parameters being not part of the corresponding sample parameters, along with the confirmed decision variables into the trained predictive model and verifying whether the prediction result output by the trained predictive model matches the target result; performing the foregoing steps of selecting the candidate sample and verifying whether the prediction result output by the trained predictive model matches the target result for all sample parameters in the dataset, and using at least one sample from the candidate samples, wherein the prediction result of the trained predictive model matches the target result, as at least one anchor sample, and forming a multi-dimensional subspace with the at least one anchor sample; determining an initial sample in the multi-dimensional subspace and obtaining a direction for the initial sample in the multi-dimensional subspace; inputting the confirmed decision variables and the other sample parameters of the initial sample, the other sample parameters being not corresponded to the confirmed decision variables, into the trained predictive model after increasing a step size along the direction to verify whether the generated prediction result matches the target result; and using the other sample parameters, the other sample parameters being not corresponded to the confirmed decision variables after increasing the step size, as the unconfirmed decision variables if the prediction result matches the target result.

Wherein, the step of selecting the candidate sample when the corresponding sample parameters are close to or match the confirmed decision variables further comprises the following steps of: calculating a first vector of the confirmed decision variables; obtaining the corresponding sample parameters from the sample parameters of the samples respectively based on the confirmed decision variables; calculating a second vector of the corresponding sample parameters; and comparing the first vector with the second vector of each of the samples and selecting a first sample as the candidate sample when the second vector of the first sample is close to or matches the first vector.

Wherein, the step of selecting the candidate sample when the corresponding sample parameters are close to or match the confirmed decision variables further comprises the following step of: calculating an angle between the first vector and the second vector of each of the samples, and selecting the sample corresponding to the second vector with a smallest angle with the first vector as the first sample.

Wherein, the step of selecting the candidate sample when the corresponding sample parameters are close to or match the confirmed decision variables further comprises the following step of: calculating a distance between an endpoint coordinate of the first vector and an endpoint coordinate of the second vector of each of the samples with a distance function, and selecting the sample corresponding to the second vector with a smallest distance from the first vector as the first sample.

Wherein, the step of determining the initial sample in the multi-dimensional subspace further comprises the following step of: using a distance midpoint between at least two anchor samples in the multi-dimensional subspace as the initial sample.

Wherein, the step of determining the initial sample in the multi-dimensional subspace further comprises the following step of: using a linear combination of at least two of the anchor samples in the multi-dimensional subspace as the initial sample.

Wherein, the step of determining the initial sample in the multi-dimensional subspace further comprises the following step of: using the numerical analysis method to calculate a second directional derivative of the initial sample along each of the anchor samples, and as the direction for the initial sample.

Wherein, the step of determining the initial sample in the multi-dimensional subspace further comprises the following step of: setting the initial sample as an origin, using the numerical analysis method to calculate a second directional derivative of the origin toward each of the anchor samples, and as the direction for the initial sample.

Wherein, wherein the trained predictive model is represented by an objective function and the step of obtaining the direction for the initial sample in the multi-dimensional subspace further comprises the following step: using the numerical analysis method to calculate a function change value of the objective function based on a distance change value of the initial sample toward each of the anchor samples to obtain a cutline directional derivative of the initial sample toward each of the anchor samples.

Wherein, the step of obtaining the direction for the initial sample in the multi-dimensional subspace further comprises the following step: sequentially increasing and adjusting the step size of the initial sample toward a directional derivative of each of the anchor samples; sequentially confirming whether the predictive result output by the trained predictive model is closer to the target result after increasing and adjusting the step size of the initial sample toward the directional derivative of each of the anchor samples; if confirming that the predictive result output by the trained predictive model is closer to the target result after increasing the step size of the initial sample toward the directional derivative of one of the anchor samples, then using the directional derivative as the direction of the initial sample and increasing the step size of the initial sample in the direction; and if confirmed that the predictive result output by the trained predictive model is not closer to the target result after increasing the step size of the initial sample toward the directional derivative of one of the anchor samples, then confirming whether the predictive result output by the trained predictive model is closer to the target result after increasing the step size of the initial sample toward the directional derivative of another one of the anchor samples.

Another scope of the present invention is to provide a method for calculating decision variables configured to calculate a plurality of unconfirmed decision variables. The method for calculating decision variables comprises the following steps of: providing a trained predictive model, the trained predictive model being obtained by machine learning through a neural network method on a dataset comprising a plurality of samples, each of the samples comprising a plurality of sample parameters, the trained predictive model comprising an input layer and an output layer, a number of input terminals of the input layer being the same as a total number of the unconfirmed decision variables and a plurality of confirmed decision variables; comparing the confirmed decision variables with a plurality of corresponding sample parameters corresponding to the confirmed decision variables in the sample parameters to select a first sample when the corresponding sample parameters are close to or match the confirmed decision variables; and inputting the confirmed decision variables and the other sample parameters of the first sample, the other sample parameters being not part of the corresponding sample parameters, into the trained predictive model, and using the other sample parameters as an initial weight value if the prediction result output by the trained predictive model matches the target result; adding a dummy layer connected to the input layer of the trained predictive model, the dummy layer comprising a plurality of artificial neurons, each of the artificial neurons being respectively connected to each of the input terminal of the input layer, a parameter predictive model formed from the trained predictive model and the dummy layer, and the predicted result of the trained predictive model served as an output of the parameter predictive model; setting a bias value of an activation function for each of the artificial neurons to 0, wherein when an input value of the activation function is 1, an output value of the activation function is 1; assigning a plurality of first weight values between a plurality of first artificial neuron of the artificial neurons respectively corresponding to the confirmed decision variables and the input terminals based on the confirmed decision variables; and setting the output of the parameter predictive model to be corresponding to the target result and inputting a training dataset comprising at least one all-one vector into the artificial neurons of the dummy layer of the parameter predictive model to train the parameter predictive model, an optimizer generated from the neural network method of the trained predictive model to adjust a plurality of second reference weight values between each of the artificial neurons and the input layer starting from the initial weight value based on the target result, and using the second reference weight values as the unconfirmed decision variables.

Wherein, the trained predictive model comprises a plurality of model parameters, and the plurality of model parameters are fixed.

Wherein, the first weight values are fixed.

Wherein, the neural network method comprises one of an Artificial Neural Network (ANN), a Convolutional Neural Network (CNN), a Recurrent Neural Network (RNN), a Recursive Neural Network (RecNN), or a Complex Neural Network.

Wherein, the optimizer is further selected from the group consisting of Adaptive Moment Estimation (Adam), Stochastic Gradient Descent (SGD), Momentum, Nesterov Accelerated Gradient (NAG), Adaptive Gradient Algorithm (AdaGrad), Nesterov-accelerated Adaptive Moment Estimation (Nadam), Root Mean Square Propagation (RMSprop), Adaptive Delta (Adadelta), Adam with Weight Decay (AdamW), Adaptive Moment Estimation with Long-term Memory (AMSGrad), Adaptive Belief (AdaBelief), Layer-wise Adaptive Rate Scaling (LARS), AdaHessian, Rectified Adam (RAdam), Lookahead, Momentumized, Adaptive, and Decentralized Gradient Descent (MadGrad), Yogi optimizer, and Adaptive Moment Estimation with Maximum (AdamMax).

In summary, the method for calculating decision variables of the present invention can perform reverse derivation on a predictive model obtained through machine learning training to calculate decision variables that meet the target result, also known as the ground truth. Specifically, the method for calculating decision variables can transform a constrained objective function of the trained predictive model into an unconstrained objective function to optimize the solution for the unconstrained objective function. During the optimization process, the anchor samples can be set to form a multi-dimensional feasible solution space, and the optimal solution can be found within this space. The process can consider the initial solutions, the directions, and the step sizes, wherein the initial solution can be obtained from the sample set used in training the predictive model, such as using the samples with the sample parameters close to or matching the confirmed decision variables as the initial solution. The optimizer on the platform used to train the predictive model can provide the gradient at any point in the initial solution or feasible solution space, and the opposite direction of the gradient can be used as the direction. Finally, continuous adjustments to the direction and the step size can be made from the initial solution to calculate the optimal solution that meets the target result as the unconfirmed decision variables. Determining the direction can also involve using numerical methods to estimate the unconstrained objective function. On the other hand, the method for calculating decision variables of the present invention can directly train a trained predictive model with the addition of the dummy layer by the optimizer. The method can also use the samples in the sample set used in the training of the trained predictive model as the initial weight values to train to obtain the arc weights between the dummy layer and the trained predictive model, and use the arc weights as the decision variables.

### BRIEF DESCRIPTION OF THE APPENDED DRAWINGS

FIG. 1 is a flowchart diagram illustrating a method for calculating decision variables according to an embodiment of the present invention.

FIG. 2 is a flowchart diagram illustrating the further steps of the method for calculating decision variables shown in FIG. 1.

FIG. 3 is a flowchart diagram illustrating the method for calculating decision variables according to another embodiment of the present invention.

FIG. 4 is a flowchart diagram illustrating the method for calculating decision variables according to another embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

In the description of this specification, the description with reference to the terms “an embodiment”, “another embodiment” or “part of an embodiment” means that a particular feature, structure, material or characteristic described in connection with the embodiment including in at least one embodiment of the present invention. In this specification, the schematic representations of the above terms do not necessarily refer to the same embodiment. Furthermore, the particular features, structures, materials or characteristics described may be combined in any suitable manner in one or more embodiments. Furthermore, the indefinite articles “a” and “an” preceding a device or element of the present invention are not limiting on the quantitative requirement (the number of occurrences) of the device or element. Thus, “a” should be read to include one or at least one, and a device or element in the singular also includes the plural unless the number clearly refers to the singular.

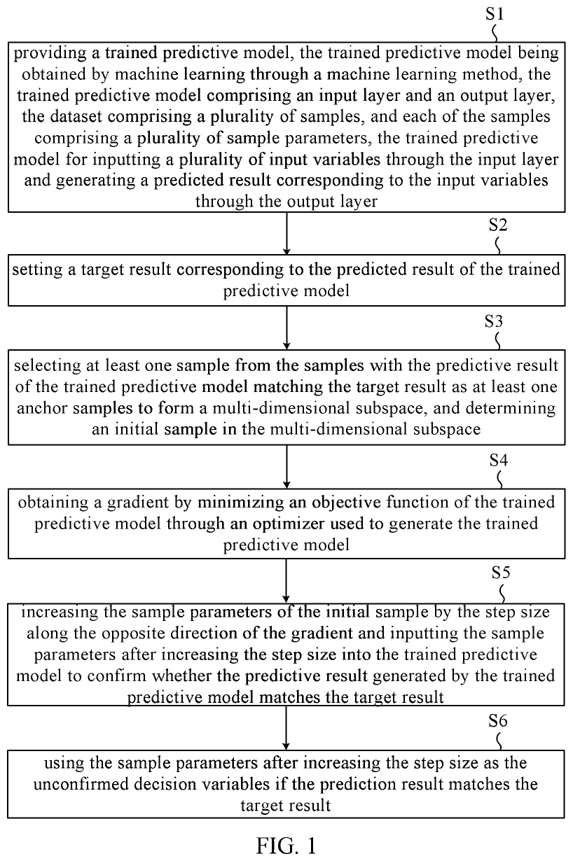

Please refer to FIG. 1. FIG. 1 is a flowchart diagram illustrating a method for calculating decision variables according to an embodiment of the present invention. The method for calculating decision variables is configured to calculate a plurality of unconfirmed decision variables. In the decision variables, the confirmed decision variables are those that have already been confirmed or executed by the user, while the unconfirmed decision variables are those that have not yet been confirmed or executed by the user. As shown in FIG. 1, in the present embodiment, the method for calculating decision variables comprises the following steps: step S1: providing a trained predictive model, the trained predictive model being obtained by machine learning through a machine learning method, the trained predictive model comprising an input layer and an output layer, the dataset comprising a plurality of samples, and each of the samples comprising a plurality of sample parameters, the trained predictive model for inputting a plurality of input variables through the input layer and generating a predicted result corresponding to the input variables through the output layer; step S2: setting a target result corresponding to the predicted result of the trained predictive model; step S3: selecting at least one sample from the samples with the predictive result of the trained predictive model matching the target result as at least one anchor samples to form a multi-dimensional subspace, and determining an initial sample in the multi-dimensional subspace; step S4: obtaining a gradient by minimizing an objective function of the trained predictive model through an optimizer used to generate the trained predictive model; step S5: increasing the sample parameters of the initial sample by the step size along the opposite direction of the gradient and inputting the sample parameters after increasing the step size into the trained predictive model to confirm whether the predictive result generated by the trained predictive model matches the target result; and step S6: using the sample parameters after increasing the step size as the unconfirmed decision variables if the prediction result matches the target result.

In this embodiment, the trained predictive model in step S1 can be any model obtained from a publicly available platform trained using machine learning or a predictive model trained by the user through machine learning. Additionally, the dataset in this embodiment can be any data collection used for machine learning training, testing, and validation. In practice, the method for calculating decision variables of the present embodiment can be applied to other trained machine learning models to deduce and determine the unconfirmed decision variables in reverse. Furthermore, the trained predictive model in the present embodiment can be obtained through machine learning applied to the dataset using an Artificial Neural Network (ANN), a Convolutional Neural Network (CNN), a Recurrent Neural Network (RNN), or any other machine learning algorithms or neural network algorithms. The selection of the machine learning or neural network algorithms can be based on user requirements.

In step S2, the user can first set a target result, also known as the ground truth, which is the expected goal for the decision variables calculated by the method for calculating decision variables of the present invention. Since the method for calculating decision variables is based on a trained predictive model for reverse deduction, and an objective function can represent the trained predictive model. Therefore, the process of the reverse deduction of the trained predictive model to obtain decision variables can be viewed as solving an optimization problem for the objective function. Solving the optimization problem can be more efficient if the feasible solution space is first obtained and solved in this space. In step S3, the samples used during the trained predictive model can be utilized to form the aforementioned feasible solution space.

Specifically, the samples in the dataset, whose output prediction results are known when input into the trained predictive model, are valuable references for solving the decision variables if their prediction results meet the target results. Therefore, the samples can be designated anchor samples to form the multi-dimensional subspace, constituting the feasible solution space. Furthermore, once the multi-dimensional subspace is determined, an initial point in the multi-dimensional subspace can be selected to begin solving the optimization problem, with this initial point referred to as the initial sample in step S3.

As previously mentioned, after determining the initial sample in the feasible solution space, the optimization problem-solving process can begin from this initial sample. Specifically, the process involves moving one step size in a direction from the initial sample and then inputting the sample parameters, increased by the step size, into the trained predictive model to verify if the output prediction result meets the target result or if the gap between the prediction result and the target result decreases. Repeating this step size adjustment method ultimately yields input parameters that produce an output prediction result that completely meets the target result or has the smallest gap from the target result. The input parameters can be designated as the unconfirmed decision variables, as described in steps S5 and S6. However, determining the direction of each of the points in the optimization problem-solving process, including the initial sample, generally involves obtaining the gradient through partial differentiation of the objective function, and the opposite direction of the gradient can be used as the direction. Since the objective function of the trained predictive model is often not symbolic and can be non-differentiable or even discontinuous, directly calculating its derivative is challenging. Numerical analysis methods can instead be used to approximate the gradient. However, using numerical analysis methods to approximate the derivative (or gradient) of the objective function consumes significant computational resources and introduces overhead and inaccuracy issues. Therefore, in step S4 of the present embodiment, the optimizer initially used to generate the trained model can obtain the gradient by minimizing the objective function of the trained predictive model. For example, using the Stochastic Gradient Descent (SGD) optimizer allows for gradient calculation while minimizing the objective function. Compared to numerical analysis methods, using an optimizer to calculate the gradient can precisely determine the gradient while significantly saving computational resources.

In the aforementioned embodiment, the feasible solution space can be derived from the samples in the dataset, i.e., selecting the samples with prediction results that match or are close to the target results as anchor samples. However, in practice, not all decision variables are unconfirmed; there can also be situations where both confirmed and unconfirmed decision variables exist simultaneously. For example, suppose a user intends to conduct a 21-day cell culture process with the expectation that the resulting cell preparation will have 95% cell viability, and the user has already carried out the first 7 days of the culture process (i.e., there are 7 days of confirmed decision variables). In that case, the process parameters for days 8 to 21 (i.e., the unconfirmed decision variables) are yet to be confirmed or adjusted to achieve the desired target result on the 21st day. If only the samples with prediction results matching or close to the target results are selected as anchor samples and an initial sample is randomly chosen from the feasible solution space formed by the anchor samples for solving the optimization problem, the final decision variables for the first 7 days will usually differ significantly from the confirmed decision variables.

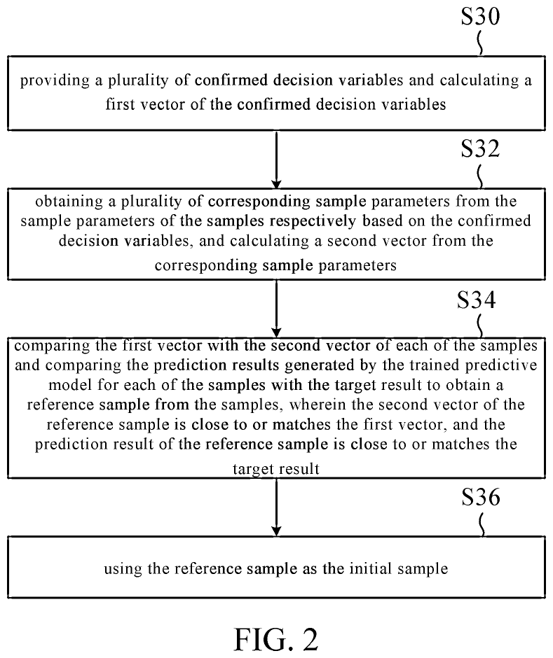

Please refer to FIG. 2. FIG. 2 is a flowchart diagram illustrating the further steps of the method for calculating decision variables shown in FIG. 1. As shown in FIG. 2, the difference in the present embodiment from the aforementioned embodiment is that the process in the present embodiment further includes the following steps: step S30: providing a plurality of confirmed decision variables and calculating a first vector of the confirmed decision variables; step S32: obtaining a plurality of corresponding sample parameters from the sample parameters of the samples respectively based on the confirmed decision variables, and calculating a second vector from the corresponding sample parameters; step S34: comparing the first vector with the second vector of each of the samples and comparing the prediction results generated by the trained predictive model for each of the samples with the target result to obtain a reference sample from the samples, wherein the second vector of the reference sample is close to or matches the first vector, and the prediction result of the reference sample is close to or matches the target result; and step S36: using the reference sample as the initial sample.

The aforementioned step of determining the reference sample is based on whether its second vector is close to or matches the first vector. In practice, determining whether the two vectors are close to or match each other can be determined by recognizing that the angle between the two vectors is close to 0 degrees or 0 degrees. Specifically, in an embodiment, the step of determining the reference sample can include the following steps: calculating an angle between the first vector and the second vector of each of the samples, and selecting the sample corresponding to the second vector with a smallest angle (close to or equal to 0 degrees) with the first vector as the reference sample. Alternatively, in another embodiment, the step of determining the reference sample can include the following steps: calculating a distance between an endpoint coordinate of the first vector and an endpoint coordinate of the second vector of each of the samples with a distance function, and selecting the sample corresponding to the second vector with a smallest distance from the first vector as the reference sample. In practice, the distance function in the machine learning includes Euclidean Distance, Manhattan Distance, Cosine Similarity, Jaccard Similarity, and Mahalanobis Distance. The method for calculating the smallest distance and the applicable range for this minimum distance can be set according to user requirements.

Since the vector formed by the reference sample parameters corresponding to the confirmed decision variables (e.g., the cell process parameters for the first 7 days) is close to or matches the vector of the confirmed decision variables, this indicates that the reference sample parameters are close to or match the confirmed decision variables. Therefore, using the reference sample as the initial sample, the optimal solution obtained from the aforementioned optimization problem-solving process can be applied to scenarios where some decision variables are already confirmed (e.g., the cell process parameters for the first 7 days) and some decision variables are unconfirmed (e.g., the cell process parameters for days 8 to 21).

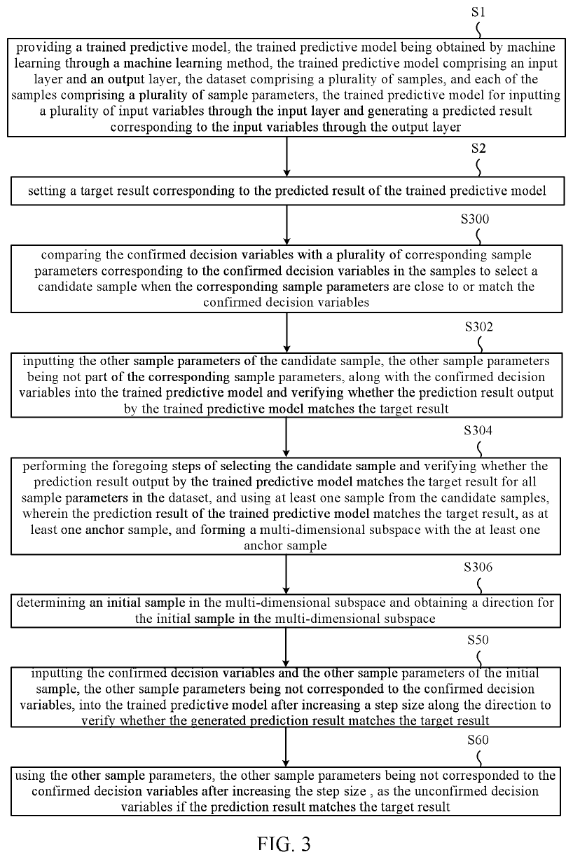

Please refer to FIG. 3 FIG. 3 is a flowchart diagram illustrating the method for calculating decision variables according to another embodiment of the present invention. As shown in FIG. 3, the difference in the present embodiment compared to the aforementioned embodiment is that the method for calculating decision variables further includes the following steps: step S300: comparing the confirmed decision variables with a plurality of corresponding sample parameters corresponding to the confirmed decision variables in the samples to select a candidate sample when the corresponding sample parameters are close to or match the confirmed decision variables; step S302: inputting the other sample parameters of the candidate sample, the other sample parameters being not part of the corresponding sample parameters, along with the confirmed decision variables into the trained predictive model and verifying whether the prediction result output by the trained predictive model matches the target result; step S304: performing the foregoing steps of selecting the candidate sample and verifying whether the prediction result output by the trained predictive model matches the target result for all sample parameters in the dataset, and using at least one sample from the candidate samples, wherein the prediction result of the trained predictive model matches the target result, as at least one anchor sample, and forming a multi-dimensional subspace with the at least one anchor sample; step S306: determining an initial sample in the multi-dimensional subspace and obtaining a direction for the initial sample in the multi-dimensional subspace; step S50: inputting the confirmed decision variables and the other sample parameters of the initial sample, the other sample parameters being not corresponded to the confirmed decision variables, into the trained predictive model after increasing a step size along the direction to verify whether the generated prediction result matches the target result; and step S60: using the other sample parameters, the other sample parameters being not corresponded to the confirmed decision variables after increasing the step size, as the unconfirmed decision variables if the prediction result matches the target result. Note that the other steps in the method for calculating decision variables of the present embodiment are substantially similar to those described in the previous embodiments and would not be described again herein.

The difference between the present embodiment and the aforementioned embodiment is that, in the present embodiment, the confirmed decision variables are first used to select samples with corresponding sample parameters as candidate samples. Then, the confirmed decision variables and the other sample parameters of the candidate samples, which do not correspond to the confirmed decision variables (i.e., the unconfirmed part), are combined and input into the trained predictive model. When the prediction result output by the trained predictive model matches the target result, it indicates that the sample parameters corresponding to the unconfirmed part in the candidate sample are valuable references. Therefore, the candidate sample can be an anchor sample to form the feasible solution space (multi-dimensional subspace). Similarly, starting the optimization problem-solving process with an initial sample and determining the direction and step size is still necessary in the multi-dimensional subspace, as shown in step S306. In the present embodiment, the direction in step S306 is determined by calculating the gradient of the objective function using numerical analysis methods and using the opposite direction of the gradient as the direction. Since the confirmed decision variables are fixed, step S50 involves increasing the other sample parameters of the initial sample by one step size along the determined direction and then inputting them, along with the confirmed decision variables, into the trained predictive model to verify if the prediction result matches the target result. This process of determining the direction and increasing the step size can be repeated to make the prediction result continuously approach the target result until it matches the target result. Finally, in step S60, when the step size is continuously increased until the prediction result matches the target result, or in practice when the difference between the prediction result and the target result is minimized, the sample parameters of the non-corresponding confirmed decision variables, increased by the step size, are designated as the unconfirmed decision variables.

In this embodiment, step S300 of determining candidate samples is based on whether their second vectors are close to or match the first vector. As mentioned, the first vector is the vector calculated from the confirmed decision variables, while the second vector is the vector calculated from the sample parameters corresponding to the confirmed decision variables. Practically, determining whether the two vectors are close or match can be done by checking if the angle between the two vectors is close to or equal to 0 degrees. Specifically, in an embodiment, the step of determining candidate sample can include the following steps: calculating an angle between the first vector and the second vector of each of the samples, and selecting the sample corresponding to the second vector with a smallest angle (close to or equal to 0 degrees) with the first vector as the candidate sample. Alternatively, in another embodiment, the step of determining the candidate sample can include the following steps: calculating a distance between an endpoint coordinate of the first vector and an endpoint coordinate of the second vector of each of the samples with a distance function, and selecting the sample corresponding to the second vector with a smallest distance from the first vector as the candidate sample. In practice, the distance function in the machine learning includes Euclidean Distance, Manhattan Distance, Cosine Similarity, Jaccard Similarity, and Mahalanobis Distance. The method for calculating the smallest distance and the applicable range for this minimum distance can be set according to user requirements.

As mentioned above, in the present embodiment, step S300 involves determining the initial sample in the multi-dimensional subspace (feasible solution space). The method for determining the initial sample in practice can involve any one or a combination of the following steps: using a distance midpoint between at least two anchor samples in the multi-dimensional subspace as the initial sample; or using a linear combination of at least two of the anchor samples in the multi-dimensional subspace as the initial sample. Since each anchor sample is selected from the candidate samples, and its corresponding sample parameters match or are close to the confirmed decision variables, the corresponding sample parameters in the initial sample determined by the above steps will also match or be close to the confirmed decision variables.

Additionally, as previously mentioned, in the multi-dimensional subspace, the direction for the initial sample or subsequent sample after at least one step size increase is determined by calculating the gradient of the objective function using numerical analysis methods and taking the opposite direction of the gradient. In practice, the process for determining the direction can involve any one or a combination of the following steps: using the numerical analysis method to calculate a directional derivative of the initial sample along each of the anchor samples, and as the direction for the initial sample (or subsequent sample); setting the initial sample (or subsequent sample) as an origin, using the numerical analysis method to calculate the directional derivative of the origin toward each of the anchor samples, and as the direction for the initial sample (or subsequent sample); or using the numerical analysis method to calculate a function change value of the objective function based on a distance change value of the initial sample (or subsequent sample) toward each of the anchor samples to obtain a cutline directional derivative of the initial sample (or subsequent sample) toward each of the anchor samples.

When the initial sample moves in the opposite direction of the feasible solution, the function value might deteriorate or not meet expectations. Therefore, the direction determination method can also involve sequentially finding a direction that improves the function value. According to another embodiment, the direction determination method can include the following steps: sequentially increasing and adjusting the step size of the initial sample toward a directional derivative of each of the anchor samples; sequentially confirming whether the predictive result output by the trained predictive model is closer to the target result after increasing and adjusting the step size of the initial sample toward the directional derivative of each of the anchor samples; if confirming that the predictive result output by the trained predictive model is closer to the target result after increasing the step size of the initial sample toward the directional derivative of one of the anchor samples, then using the directional derivative as the direction of the initial sample and increasing the step size of the initial sample in the direction; and if confirmed that the predictive result output by the trained predictive model is not closer to the target result after increasing the step size of the initial sample toward the directional derivative of one of the anchor samples, then confirming whether the predictive result output by the trained predictive model is closer to the target result after increasing the step size of the initial sample toward the directional derivative of another one of the anchor samples. After the initial sample progresses one step size to reach the subsequent sample or intermediate sample, the steps above can continue to find a new direction and proceed to the next step size. In summary, the direction determination method of the present embodiment can involve repeatedly adjusting the step size from the initial sample towards the direction of the first anchor sample and confirming whether the prediction result becomes closer to the target result after increasing the step size. If an appropriate step size is found, proceed in this direction with the determined step size. However, if a suitable step size is not found after a certain number of adjustments, move toward the direction of the following anchor sample and repeat the process. In practice, if no suitable step size can be found in the direction of any of the anchor samples to improve the function value (i.e., reducing the difference between the prediction result and the target result), the method for calculating decision variables stops. Additionally, the above steps are steps in a cyclical exploration. When the initial sample moves to the following subsequent sample or intermediate sample in the feasible solution space, the subsequent sample or intermediate sample can be set as the current solution, and the steps are repeated.

As mentioned above, the method for calculating decision variables in the present embodiment solves the optimization problem of the objective function of the trained predictive model to obtain the input decision variables. However, there might also be interdependencies between the decision variables. For example, in a manufacturing process, the process parameters (decision variables) are not set arbitrarily; they might have various constraints based on actual conditions, such as inequality conditions or equality conditions between a plurality of process parameters. Therefore, when constructing the optimization problem, the constraints must be considered to ensure that the final decision variables are practical. In the present embodiment, the objective function of the trained predictive model can incorporate barrier functions and penalty functions to transform the original constrained optimization problem into an unconstrained optimization problem. Therefore, there is no need to consider the constraints in the subsequent solution process, because the constraints have already been added directly to the objective function in the form of barrier functions and penalty functions.

In the present embodiment, the barrier function is set to constrain the process parameters to meet an inequality condition. The barrier function includes a barrier region and a barrier function value. When the process parameters satisfy the inequality condition, they fall outside the barrier region, resulting in a barrier function value of 0, which means it has no impact on the predictive results of the trained predictive model. Conversely, when the process parameters do not satisfy the inequality condition, they fall within the barrier region, resulting in a significantly larger barrier function value, which substantially affects the predictive results of the trained predictive model.

The penalty function is set to constrain the process parameters to meet an equality condition. The penalty function includes a penalty region and a penalty function value. When the process parameters satisfy the equality condition, they fall within the penalty region, resulting in a penalty function value 0. When the process parameters do not fulfill the equality condition, they fall outside the penalty region, resulting in a significantly larger penalty function value, substantially affecting the predictive results of the trained predictive model. Therefore, when the sample parameters are input into the trained predictive model with a barrier function and a penalty function, it verifies whether the generated predictive results meet the target results and determines whether the input parameters comply with the actual constraints. If the input process parameters do not meet the conditions of the barrier function and/or penalty function, the predictive results will significantly deviate, indicating that the process parameters cannot be used due to the violation of conditions

As an example of the aforementioned actual constraints, in a cell culture process, the combined antibiotic concentration of streptomycin and amphotericin B added to the cell culture medium on day 10 must be less than or equal to 200 μg/mL, and the combined serum concentration in the cell culture medium on days 8 and 10 must be less than or equal to 20%.

In practice, the penalty function and the barrier functions are commonly used in machine learning to keep the parameters of machine learning models within reasonable bounds, ensuring they adhere to natural environments and actual process conditions. For example, the functions can restrict cell culture temperatures and relative humidity to non-negative values and prevent culture medium component concentrations from harming the cells. By setting the barrier functions and the penalty functions to limit the range of parameters, the relationships between parameters are comprehensively considered, and the process parameter combination closest to the expected target result is found. Furthermore, in practice, the barrier functions can be applied to unconfirmed input parameters, while the penalty functions can be applied to confirmed input parameters. Both can be used interchangeably based on user requirements.

The method for calculating decision variables described in the above embodiments can be applied to cell culture processes. When the method for calculating decision variables of the present embodiment is applied to cell culture processes, the dataset used to train the trained predictive model can further include a cell dataset. The cell dataset can comprise a plurality of cell samples, and each of the sample parameters of the cell samples comprises a source parameter and a culture parameter. In practice, the cell dataset can be obtained from any public platform or collected by the user. In addition, the types of the cell samples can include immune cells (such as dendritic cells (DC cells), cytokine-induced killer cells (CIK), tumor-infiltrating lymphocytes (TIL), natural killer cells (NK cells), and CAR-T cells), stem cells (such as peripheral blood stem cells, adipose stem cells, and bone marrow mesenchymal stem cells), chondrocytes, fibroblasts, etc. In practice, it is not limited to the aforementioned, and it can be decided according to the type of cell culture that the user needs to perform. Moreover, in the present embodiment, the source parameter of each of the cell samples can further comprise attribute data of a source of each of the cell samples. Each of the cell samples in the cell dataset can comprise information about the source associated with the cell and the attribute data of the source, and the attribute data can be physiological data or other relevant data about the source, such as gender, age, medical history, living environment, geographical area of residence. In practice, it is not limited to the aforementioned; the source parameter of the cell samples can further include other parameters that can influence the cell process and are related to the origin of the cells.

Furthermore, the culture parameter of each of the cell samples further comprises operation, tool, material, method, and environment data for each of the cell samples. The cell culture process comprises many steps, and each of the steps can include numerous culture parameters. The parameters include those related to people (operation), such as the gender and age of the cell source, the experience and consistency of the cell culture operator, and the personnel, location, environment, and transportation variances associated with the surgical procedure. The parameters include those related to machinery (tool), such as the type and grade of the cell operation platform and the stability and accuracy of temperature and humidity control in the cell culture incubators. The parameters include those related to material, such as the material of the cell culture dishes and the components and ratios of the cell culture medium. The parameters include those related to the method, such as the techniques of the cell culture operators and the methods of the cell culture process. The parameters include those related to the environment, such as the ambient temperature, humidity, carbon dioxide concentration, and concentration of organic molecules in the cell culture environment.

Although the aforementioned embodiment pertains to scenarios in cell culture processes, the method for calculating decision variables of the invention is not limited to the cell process field. It can also be applied to any other field where results can be predicted through a machine learning-derived predictive model to deduce the decision variables required to achieve the target results.

In the method for calculating decision variables of the present embodiment described above, the step of calculating the gradient using numerical analysis methods can further include the following steps: setting the change value of a sample parameter in the samples, adding the change value to the vector dimension of the sample parameter, and inputting the sample parameter with the added change value into the objective function of the trained predictive model to obtain the function change value. After performing the above steps for all sample parameters, the gradient of the sample parameters of the first sample is calculated by concatenating all function change values and the sample parameters with the added change value in all vector dimensions. Practically, the gradient calculation is not limited to the aforementioned; other methods can also be selected based on user requirements, the type of machine learning model, or different usage scenarios.

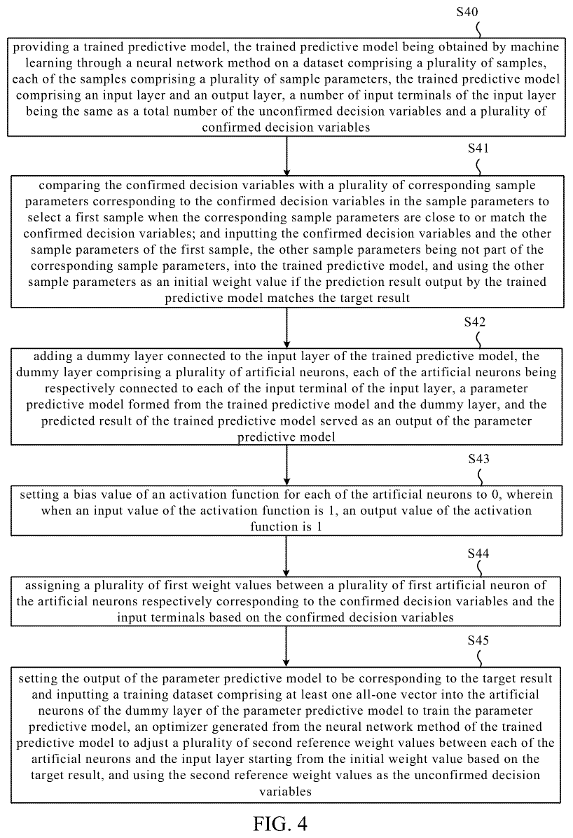

In addition to the aforementioned embodiments, the method for calculating decision variables of the present invention can have another aspect. Please refer to FIG. 4. FIG. 4 is a flowchart diagram illustrating the method for calculating decision variables according to another embodiment of the present invention. As shown in FIG. 4, the present embodiment of the method for calculating decision variables includes the following steps: step 40: providing a trained predictive model, the trained predictive model being obtained by machine learning through a neural network method on a dataset comprising a plurality of samples, each of the samples comprising a plurality of sample parameters, the trained predictive model comprising an input layer and an output layer, a number of input terminals of the input layer being the same as a total number of the unconfirmed decision variables and a plurality of confirmed decision variables; step S41: comparing the confirmed decision variables with a plurality of corresponding sample parameters corresponding to the confirmed decision variables in the sample parameters to select a first sample when the corresponding sample parameters are close to or match the confirmed decision variables; and inputting the confirmed decision variables and the other sample parameters of the first sample, the other sample parameters being not part of the corresponding sample parameters, into the trained predictive model, and using the other sample parameters as an initial weight value if the prediction result output by the trained predictive model matches the target result; step S42: adding a dummy layer connected to the input layer of the trained predictive model, the dummy layer comprising a plurality of artificial neurons, each of the artificial neurons being respectively connected to each of the input terminal of the input layer, a parameter predictive model formed from the trained predictive model and the dummy layer, and the predicted result of the trained predictive model served as an output of the parameter predictive model; step S43: setting a bias value of an activation function for each of the artificial neurons to 0, wherein when an input value of the activation function is 1, an output value of the activation function is 1; step S44: assigning a plurality of first weight values between a plurality of first artificial neuron of the artificial neurons respectively corresponding to the confirmed decision variables and the input terminals based on the confirmed decision variables; and step S45: setting the output of the parameter predictive model to be corresponding to the target result and inputting a training dataset comprising at least one all-one vector into the artificial neurons of the dummy layer of the parameter predictive model to train the parameter predictive model, an optimizer generated from the neural network method of the trained predictive model to adjust a plurality of second reference weight values between each of the artificial neurons and the input layer starting from the initial weight value based on the target result, and using the second reference weight values as the unconfirmed decision variables.

In the present embodiment, since the confirmed decision variables are fixed decision variables, the first weight values are given values and are not allowed to be modified or adjusted by the optimizer. The optimizer can change only the second weight values between the artificial neurons, other than the first artificial neuron, and the input layer.

The trained predictive model in the present embodiment can be obtained by applying machine learning to the dataset through an Artificial Neural Network (ANN), a Convolutional Neural Network (CNN), a Recurrent Neural Network (RNN), a Recursive Neural Network (RecNN), a Complex Neural Network, or other machine learning algorithms or neural network algorithms to perform machine learning on the dataset. The selection of the machine learning or neural network algorithms is based on user requirements.

Specifically, in the present embodiment, the method for calculating decision variables involves adding the dummy layer in step S42 to connect to the input layer of the trained predictive model, thus forming the parameter predictive model. The dummy layer contains the same number of artificial neurons as the input terminals of the input layer in the trained predictive model. A new connection is established between each of the artificial neurons of the dummy layer and its corresponding input terminal. Next, in step S43, the bias value of the activation function of the artificial neurons in the dummy layer is set to 0. Therefore, when the input value of the activation function is 1 (i.e., the input to the artificial neuron is 1), the output value of the activation function is 1 (i.e., the input to the artificial neuron is 1). In the present embodiment, the activation function ensures that the second weight values retain their original values. Following this, step S45 involves training the newly formed parameter predictive model by inputting a training dataset containing a plurality of all-one vectors into the dummy layer (which now acts as the new input layer of the parameter predictive model). Wherein, each of the all-one vectors represents an input of 1 for each of the artificial neurons. The target result is used as the ground truth for the output of the parameter predictive model. During the training process, the optimizer can adjust the arc weights between the artificial neurons and the input terminals of the trained predictive model. It should be noted that during the training process in step S45, the parameters and the first weight values in the trained predictive model are fixed or frozen, meaning the optimizer does not adjust the parameters and the first weight values in the trained predictive model. Instead, the optimizer only adjusts the second weight values to minimize the difference between the output value (predicted result) of the parameter predictive model and the ground truth (target result).

Upon the completion and convergence of the training, the second weight values adjusted by the optimizer, combined with the fixed first weight values, represent the optimal decision variables (including both confirmed and unconfirmed). Moreover, due to the many-to-one characteristic of the parameter predictive model (i.e., a plurality of different input parameters can correspond to the same output result), each of the training data (all-one vector) can obtain a set of second weight values as the optimal input decision variables. Specifically, even though the trained predictive model itself cannot deduce the input decision variables in reverse from the predicted result, the parameter predictive model in the present embodiment can achieve this by adding a dummy layer, fixing the bias values of the artificial neurons in the dummy layer, fixing the training input values, freezing the parameters in the trained predictive model, freezing the first weight values, and minimizing the difference between the output value and the target result. The second weight values can be deduced in reverse and used as the unconfirmed input parameters or decision variables through these methods.

In practice, the optimizer can be selected from the group consisting of Adaptive Moment Estimation (Adam), Stochastic Gradient Descent (SGD), Momentum, Nesterov Accelerated Gradient (NAG), Adaptive Gradient Algorithm (AdaGrad), Nesterov-accelerated Adaptive Moment Estimation (Nadam), Root Mean Square Propagation (RMSprop), Adaptive Delta (Adadelta), Adam with Weight Decay (AdamW), Adaptive Moment Estimation with Long-term Memory (AMSGrad), Adaptive Belief (AdaBelief), Layer-wise Adaptive Rate Scaling (LARS), AdaHessian, Rectified Adam (RAdam), Lookahead, Momentumized, Adaptive, and Decentralized Gradient Descent (MadGrad), Yogi optimizer, and Adaptive Moment Estimation with Maximum (AdamMax).

The aforementioned Adam optimizer (Adaptive Moment Estimation optimizer) is configured to adjust the second weight values of the artificial neurons. The Adam optimizer is commonly used for training various deep learning models, including Convolutional Neural Networks (CNNs), Recurrent Neural Networks (RNNs), and self-attention models (Transformers). It is suitable for tasks such as image classification, natural language processing, and translation. The Adam optimizer adjusts the learning rate based on the gradient changes of each parameter, allowing it to have different learning rates in different directions. This capability helps better control the convergence speed of machine learning training. In practice, the selection of the optimizer is more comprehensive than the aforementioned; other optimizers that can adjust parameters and weight values can also be used based on user needs and the type of training model.

In the present embodiment, the optimizer adjusts the second weight values starting from an initial point. In practice, if the initial point is chosen well, the computational resources and time required to change the second weight values to serve as the unconfirmed decision variables will be reduced. Therefore, steps S40 to S41 in the present embodiment use the samples to train the trained predictive model as a reference.

Specifically, these steps involve comparing the confirmed decision variables with the corresponding sample parameters of each sample to determine if they are close or match and checking if the output of these samples from the trained predictive model meets the target result. Suppose there is a sample in the dataset that satisfies both conditions. In that case, it indicates that this sample not only meets the user's defined target for the prediction result but also has sample parameters corresponding to the confirmed decision variables (e.g., already implemented process parameters in a process) that are close or identical. As a result, the sample is highly representative of the actual situation. Thus, it can be used as the initial point for calculating the unconfirmed decision variables. For example, in a cell culture process on the 21st day, if the first 7 days of cell culture have already been conducted, there are already 7 days of confirmed decision variables. Therefore, the sample used as the initial point must not only have prediction results from the trained predictive model that meet the user's target (e.g., 95% cell viability) but also have sample parameters for the first 7 days that are the same or close to the already implemented process parameters. Otherwise, the subsequent process parameters adjusted by the optimizer based on this initial point will still deviate from the actual situation.

Please note that the actual execution steps of step S41 in the present embodiment can be similar to the previously mentioned method of comparing whether the first vector and the second vector are close or identical. For instance, this can be done by selecting the sample with the smallest angle between the first vector and the second vector or by using a distance function to calculate and choose the sample with the minimum distance between the endpoint coordinate of the first vector and the endpoint coordinate of the second vector. The detailed steps have been comprehensively described in the previous embodiments and will not be repeated here.

In summary, the method for calculating decision variables of the present invention can perform reverse derivation on a predictive model obtained through machine learning training to calculate decision variables that meet the target result, also known as the ground truth. Specifically, the method for calculating decision variables can transform a constrained objective function of the trained predictive model into an unconstrained objective function to optimize the solution for the unconstrained objective function. During the optimization process, the anchor samples can be set to form a multi-dimensional feasible solution space, and the optimal solution can be found within this space. The process can consider the initial solutions, the directions, and the step sizes, wherein the initial solution can be obtained from the sample set used in training the predictive model, such as using the samples with the sample parameters close to or matching the confirmed decision variables as the initial solution. The optimizer on the platform used to train the predictive model can provide the gradient at any point in the initial solution or feasible solution space, and the opposite direction of the gradient can be used as the direction. Finally, continuous adjustments to the direction and the step size can be made from the initial solution to calculate the optimal solution that meets the target result as the unconfirmed decision variables. Determining the direction can also involve using numerical methods to estimate the unconstrained objective function. On the other hand, the method for calculating decision variables of the present invention can directly train a trained predictive model with the addition of the dummy layer by the optimizer. The method can also use the samples in the sample set used in the training of the trained predictive model as the initial weight values to train to obtain the arc weights between the dummy layer and the trained predictive model, and use the arc weights as the decision variables.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for calculating decision variables, configured to calculate a plurality of unconfirmed decision variables, the method for calculating decision variables comprising the following steps of:
providing a trained predictive model, the trained predictive model being obtained by machine learning through a machine learning method, the trained predictive model comprising an input layer and an output layer, the dataset comprising a plurality of samples, and each of the samples comprising a plurality of sample parameters, the trained predictive model for inputting a plurality of input variables through the input layer and generating a predicted result corresponding to the input variables through the output layer;
setting a target result corresponding to the predicted result of the trained predictive model;
selecting at least one sample from the samples with the predictive result of the trained predictive model matching the target result as at least one anchor samples to form a multi-dimensional subspace, and determining an initial sample in the multi-dimensional subspace;
obtaining a gradient by minimizing an objective function of the trained predictive model through an optimizer used to generate the trained predictive model;
increasing the sample parameters of the initial sample by the step size along the opposite direction of the gradient and inputting the sample parameters after increasing the step size into the trained predictive model to confirm whether the predictive result generated by the trained predictive model matches the target result; and
using the sample parameters after increasing the step size as the unconfirmed decision variables if the prediction result matches the target result.

2. The method for calculating decision variables of claim 1, further comprising the following steps of:
providing a plurality of confirmed decision variables and calculating a first vector of the confirmed decision variables;
obtaining a plurality of corresponding sample parameters from the sample parameters of the samples respectively based on the confirmed decision variables, and calculating a second vector from the corresponding sample parameters;
comparing the first vector with the second vector of each of the samples and comparing the prediction results generated by the trained predictive model for each of the samples with the target result to obtain a reference sample from the samples, wherein the second vector of the reference sample is close to or matches the first vector, and the prediction result of the reference sample is close to or matches the target result; and
using the reference sample as the initial sample.

3. A method for calculating decision variables, comprising the following steps:
providing a trained predictive model, the trained predictive model being obtained by machine learning through a machine learning method on a dataset comprising a plurality of samples, each of the samples comprising a plurality of sample parameters, the trained predictive model being configured to input a plurality of decision variables and produce a predictive result corresponding to the decision variables, the decision variables comprising a plurality of confirmed decision variables and a plurality of unconfirmed decision variables;
setting a target result corresponding to the prediction result of the trained predictive model;
comparing the confirmed decision variables with a plurality of corresponding sample parameters corresponding to the confirmed decision variables in the samples to select a candidate sample when the corresponding sample parameters are close to or match the confirmed decision variables;
inputting the other sample parameters of the candidate sample, the other sample parameters being not part of the corresponding sample parameters, along with the confirmed decision variables into the trained predictive model and verifying whether the prediction result output by the trained predictive model matches the target result;
performing the foregoing steps of selecting the candidate sample and verifying whether the prediction result output by the trained predictive model matches the target result for all sample parameters in the dataset, and using at least one sample from the candidate samples, wherein the prediction result of the trained predictive model matches the target result, as at least one anchor sample, and forming a multi-dimensional subspace with the at least one anchor sample;
determining an initial sample in the multi-dimensional subspace and obtaining a direction for the initial sample in the multi-dimensional subspace;
inputting the confirmed decision variables and the other sample parameters of the initial sample, the other sample parameters being not corresponded to the confirmed decision variables, into the trained predictive model after increasing a step size along the direction to verify whether the generated prediction result matches the target result; and
using the other sample parameters, the other sample parameters being not corresponded to the confirmed decision variables after increasing the step size, as the unconfirmed decision variables if the prediction result matches the target result.

4. The method for calculating decision variables of claim 3, wherein the step of selecting the candidate sample when the corresponding sample parameters are close to or match the confirmed decision variables further comprises the following steps of:
calculating a first vector of the confirmed decision variables;
obtaining the corresponding sample parameters from the sample parameters of the samples respectively based on the confirmed decision variables;
calculating a second vector of the corresponding sample parameters; and
comparing the first vector with the second vector of each of the samples and selecting a first sample as the candidate sample when the second vector of the first sample is close to or matches the first vector.

5. The method for calculating decision variables of claim 4, wherein the step of selecting the candidate sample when the corresponding sample parameters are close to or match the confirmed decision variables further comprises the following step of:
calculating an angle between the first vector and the second vector of each of the samples, and selecting the sample corresponding to the second vector with a smallest angle with the first vector as the first sample.

6. The method for calculating decision variables of claim 4, wherein the step of selecting the candidate sample when the corresponding sample parameters are close to or match the confirmed decision variables further comprises the following step of:
calculating a distance between an endpoint coordinate of the first vector and an endpoint coordinate of the second vector of each of the samples with a distance function, and selecting the sample corresponding to the second vector with a smallest distance from the first vector as the first sample.

7. The method for calculating decision variables of claim 3, wherein the step of determining the initial sample in the multi-dimensional subspace further comprises the following step of:
using a distance midpoint between at least two anchor samples in the multi-dimensional subspace as the initial sample.

8. The method for calculating decision variables of claim 3, wherein the step of determining the initial sample in the multi-dimensional subspace further comprises the following step of:
using a linear combination of at least two of the anchor samples in the multi-dimensional subspace as the initial sample.

9. The method for calculating decision variables of claim 3, wherein the step of determining the initial sample in the multi-dimensional subspace further comprises the following step of:
using the numerical analysis method to calculate a second directional derivative of the initial sample along each of the anchor samples, and as the direction for the initial sample.

10. The method for calculating decision variables of claim 3, wherein the step of determining the initial sample in the multi-dimensional subspace further comprises the following step of:
setting the initial sample as an origin, using the numerical analysis method to calculate a second directional derivative of the origin toward each of the anchor samples, and as the direction for the initial sample.

11. The method for calculating decision variables of claim 3, wherein the trained predictive model is represented by an objective function and the step of obtaining the direction for the initial sample in the multi-dimensional subspace further comprises the following step:
using the numerical analysis method to calculate a function change value of the objective function based on a distance change value of the initial sample toward each of the anchor samples to obtain a cutline directional derivative of the initial sample toward each of the anchor samples.

12. The method for calculating decision variables of claim 3, wherein the step of obtaining the direction for the initial sample in the multi-dimensional subspace further comprises the following step:
sequentially increasing and adjusting the step size of the initial sample toward a directional derivative of each of the anchor samples;
sequentially confirming whether the predictive result output by the trained predictive model is closer to the target result after increasing and adjusting the step size of the initial sample toward the directional derivative of each of the anchor samples;
if confirming that the predictive result output by the trained predictive model is closer to the target result after increasing the step size of the initial sample toward the directional derivative of one of the anchor samples, then using the directional derivative as the direction of the initial sample and increasing the step size of the initial sample in the direction; and
if confirmed that the predictive result output by the trained predictive model is not closer to the target result after increasing the step size of the initial sample toward the directional derivative of one of the anchor samples, then confirming whether the predictive result output by the trained predictive model is closer to the target result after increasing the step size of the initial sample toward the directional derivative of another one of the anchor samples.

13. A method for calculating decision variables, configured to calculate a plurality of unconfirmed decision variables, the method for calculating decision variables comprising the following steps of:
providing a trained predictive model, the trained predictive model being obtained by machine learning through a neural network method on a dataset comprising a plurality of samples, each of the samples comprising a plurality of sample parameters, the trained predictive model comprising an input layer and an output layer, a number of input terminals of the input layer being the same as a total number of the unconfirmed decision variables and a plurality of confirmed decision variables;
comparing the confirmed decision variables with a plurality of corresponding sample parameters corresponding to the confirmed decision variables in the sample parameters to select a first sample when the corresponding sample parameters are close to or match the confirmed decision variables; and inputting the confirmed decision variables and the other sample parameters of the first sample, the other sample parameters being not part of the corresponding sample parameters, into the trained predictive model, and using the other sample parameters as an initial weight value if the prediction result output by the trained predictive model matches the target result;
adding a dummy layer connected to the input layer of the trained predictive model, the dummy layer comprising a plurality of artificial neurons, each of the artificial neurons being respectively connected to each of the input terminal of the input layer, a parameter predictive model formed from the trained predictive model and the dummy layer, and the predicted result of the trained predictive model served as an output of the parameter predictive model;
setting a bias value of an activation function for each of the artificial neurons to 0, wherein when an input value of the activation function is 1, an output value of the activation function is 1;
assigning a plurality of first weight values between a plurality of first artificial neuron of the artificial neurons respectively corresponding to the confirmed decision variables and the input terminals based on the confirmed decision variables; and
setting the output of the parameter predictive model to be corresponding to the target result and inputting a training dataset comprising at least one all-one vector into the artificial neurons of the dummy layer of the parameter predictive model to train the parameter predictive model, an optimizer generated from the neural network method of the trained predictive model to adjust a plurality of second reference weight values between each of the artificial neurons and the input layer starting from the initial weight value based on the target result, and using the second reference weight values as the unconfirmed decision variables.

14. The method for calculating decision variables of claim 13, wherein the trained predictive model comprises a plurality of model parameters, and the plurality of model parameters are fixed.

15. The method for calculating decision variables of claim 14, wherein the first weight values are fixed.

16. The method for calculating decision variables of claim 14, wherein the neural network method comprises one of an Artificial Neural Network (ANN), a Convolutional Neural Network (CNN), a Recurrent Neural Network (RNN), a Recursive Neural Network (RecNN), or a Complex Neural Network.

17. The method for calculating decision variables of claim 14, wherein the optimizer is further selected from the group consisting of Adaptive Moment Estimation (Adam), Stochastic Gradient Descent (SGD), Momentum, Nesterov Accelerated Gradient (NAG), Adaptive Gradient Algorithm (AdaGrad), Nesterov-accelerated Adaptive Moment Estimation (Nadam), Root Mean Square Propagation (RMSprop), Adaptive Delta (Adadelta), Adam with Weight Decay (AdamW), Adaptive Moment Estimation with Long-term Memory (AMSGrad), Adaptive Belief (AdaBelief), Layer-wise Adaptive Rate Scaling (LARS), AdaHessian, Rectified Adam (RAdam), Lookahead, Momentumized, Adaptive, and Decentralized Gradient Descent (MadGrad), Yogi optimizer, and Adaptive Moment Estimation with Maximum (AdamMax).
